(19) United States
(12) Patent Application Publication
(10) Pub. No.: US 2026/0208218 A1
(43) Pub. Date: Jul. 23, 2026

(54) COATING SYSTEM AND HEAD CLEANING METHOD

(71) Applicants: Tomoya TANAKA, Kanagawa (JP); Shigeru YOSHIDA, Kanagawa (JP)

(72) Inventors: Tomoya TANAKA, Kanagawa (JP); Shigeru YOSHIDA, Kanagawa (JP)

(21) Appl. No.: 19/142,649

(22) PCT Filed: Dec. 11, 2023
(86) PCT No.: PCT/IB2023/062451

§ 371 Date: Jun. 24, 2025

(30) Foreign Application Priority Data
Jan. 13, 2023 (JP) 2023-003553

(51) Int. Cl. B05B 13/04; B05B 1/30; B05B 14/00; B05B 15/55; B05B 15/58; B25J 11/00; B41J 2/165; B41J 2/175; B41J 2/18; B41J 3/407; B41J 25/00; B41J 25/304

(52) U.S. Cl. CPC B05B 13/04; B05B 1/30; B05B 14/00; B05B 15/55; B05B 15/58; B25J 11/0075; B41J 2/16552; B41J 2/17596; B41J 2/18; B41J 3/4073; B41J 25/001; B41J 25/304; B41J 2002/16555; B41J 2002/16573

(57) ABSTRACT

A coating system includes: a head having a nozzle hole through which a coating material is dischargeable; a supply path coupled to the head to supply the coating material to the head; a discharge path coupled to the head to discharge the coating material that has not been discharged through the nozzle hole; a robot including a movement mechanism to move the head attached to the movement mechanism; a switching valve coupled to multiple coating material containers containing different types of coating materials, the switching valve to switch a first type of coating material to a second type of coating material, different from the first type of coating material, to be supplied to the supply path; a discharge valve to openably close the discharge path; and a controller configured to: control the head to openably close the nozzle hole to discharge the first type of coating material.

### TECHNICAL FIELD

The present embodiment relates to a coating system and a head cleaning method.

### BACKGROUND ART

Patent Literature (PTL) 1 discloses a coating machine that includes: a nozzle head unit in which a nozzle head, a nozzle controller, and a head-side circulation path are integrally provided, the nozzle head having a nozzle for discharging a coating material, the nozzle controller controlling driving of the nozzle, the coating material circulating in the nozzle head through the head-side circulation path, the nozzle head unit being detachably attached to a chuck portion of a robot arm; and a head replacement unit for replacing the nozzle head unit attached to the chuck portion with a nozzle head unit held by a standby nozzle head unit holder.

### Citation List

### Patent Literature

### PTL 1

WO 2021/028983

### SUMMARY OF INVENTION

### Technical Problem

However, when the coating material to be used is switched to a coating material of a different kind, it is necessary to use the head replacement unit to replace the nozzle head unit with the nozzle head unit held by the standby nozzle head unit holder, and convey the used nozzle head unit to a cleaning mechanism in a station unit. Therefore, it takes a long time from the end of coating to the start of cleaning.

### Solution to Problem

In an embodiment of the present disclosure, a coating system includes: a head having a nozzle hole through which a coating material is dischargeable; a supply path coupled to the head to supply the coating material to the head; a discharge path coupled to the head to discharge the coating material that has not been discharged through the nozzle hole; a robot including a movement mechanism to move the head attached to the movement mechanism; a switching valve coupled to multiple coating material containers containing different types of coating materials, the switching valve to switch a first type of coating material to a second type of coating material, different from the first type of coating material, to be supplied to the supply path; a discharge valve to openably close the discharge path; and a controller configured to: control the head to openably close the nozzle hole to discharge the first type of coating material from the nozzle hole to perform a coating operation; open the discharge valve to discharge the first type of coating material to the discharge path, with the head attached to the movement mechanism, after completion of the coating operation; and control the switching valve to supply the second type of coating material to the supply path after completion of discharge of the first type of coating material to the discharge path.

In another embodiment of the present disclosure, a head cleaning method includes discharging a coating material from a nozzle hole of a head; supplying the coating material to the head through a supply path; discharging the coating material that has not been discharged through the nozzle hole through a discharge path; controlling a movement mechanism of a robot to move the head attached to the movement mechanism; switching a switching valve coupled to multiple coating material containers containing different types of coating materials, to switch a first type of coating material to a second type of coating material, different from the first type of coating material, to be supplied to the supply path; opening and closing a discharge valve to open and close the discharge path; controlling the head to openably close the nozzle hole to discharge the first type of coating material from the nozzle hole to perform a coating operation; opening the discharge valve to discharge the first type of coating material to the discharge path, with the head attached to the movement mechanism, after completion of the coating operation; and controlling the switching valve to supply the second type of coating material to the supply path after completion of discharge of the first type of coating material to the discharge path.

### Advantageous Effects of Invention

According to the present embodiment, the time until a start of head cleaning can be shortened.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is an overall schematic diagram illustrating an example of a coating system according to an embodiment.

FIG. 2 is a hardware block diagram of each controller according to the embodiment.

FIG. 3 is a schematic cross-sectional view of an example of a head.

FIGS. 4A and 4B are explanatory diagrams illustrating an operation of a head.

FIG. 5 is a schematic cross-sectional view of an example of a head module.

FIG. 6 is a schematic diagram illustrating the relationship between a coating robot and supply and discharge paths.

FIG. 7 is an explanatory diagram illustrating an example of the supply and discharge paths in the entire coating system.

FIG. 8 is an explanatory diagram illustrating the configuration of a switching valve.

FIG. 9 is a timing chart illustrating an example of an internal cleaning operation.

FIGS. 10A and 10B are schematic cross-sectional views illustrating another example of the head.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise.

The following is a description of a mode for carrying out an embodiment, with reference to the accompanying drawings. In the description of the drawings, like components are denoted by like reference signs, and explanation of them will not be repeated more than once.

### Outline of a Coating System

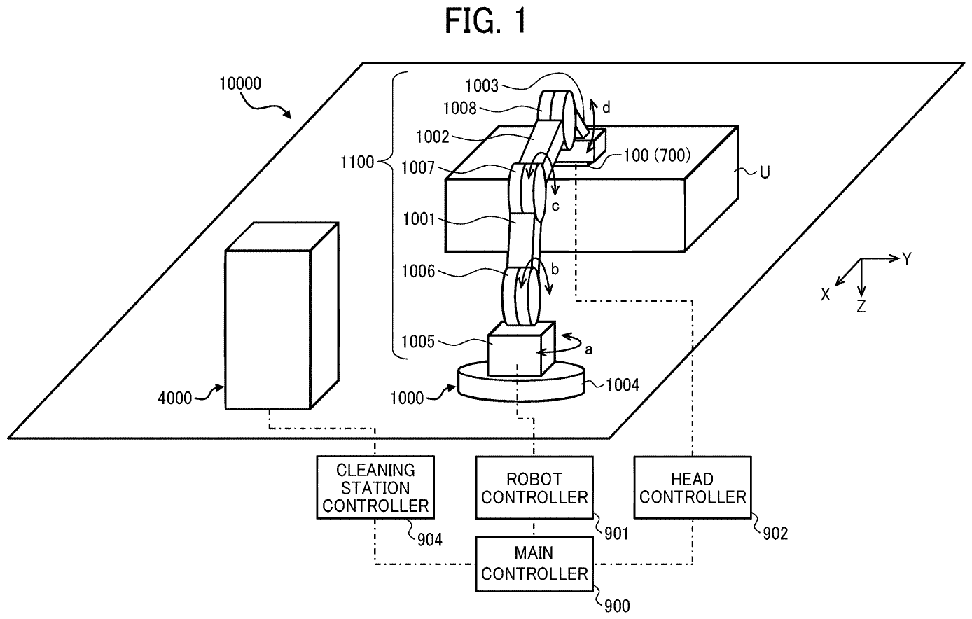

First, an outline of a coating system is described with reference to FIG. 1. FIG. 1 is an overall schematic diagram illustrating an example of a coating system according to an embodiment.

A coating system 10000 includes a coating robot 1000, a cleaning station 4000, a main controller 900, a robot controller 901, a head controller 902, and a cleaning station controller 904.

The coating robot 1000, which is an example of a robot, is an articulated robot, for example, and a head 100 (or a head module 700) is attached to the tip portion of an articulated arm device 1100. Configurations of the head 100 and the head module 700 will be described later. The coating robot 1000 can freely move the head 100 with respect to a coating target object U that is the vehicle body of an automobile, for example, and accurately position the head 100 at the coating position of the coating target object U. The head 100 positioned at the coating position discharges a coating material toward the coating target object U, to perform coating on the coating target object U.

The coating robot 1000 includes an installation base 1004, the articulated arm device 1100, a head holder 1009, and the head 100. The installation base 1004 is a base member for supporting the articulated arm device 1100. The articulated arm device 1100 includes a first arm 1001, a second arm 1002, a third arm 1003, a movable portion 1005, a first joint portion 1006, a second joint portion 1007, and a third joint portion 1008. Here, the articulated arm device 1100 is an example of a movement mechanism.

The movable portion 1005 disposed on the installation base 1004 is supported by the installation base 1004 so as to be rotatable in a horizontal direction (the direction indicated by arrow a) with respect to the installation base 1004. The first joint portion 1006 is attached to the movable portion 1005. One end portion of the first arm 1001 is coupled to the first joint portion 1006, and the first joint portion 1006 rotatably supports the first arm 1001 in the direction indicated by arrow b. The other end portion of the first arm 1001 is coupled to one end portion of the second arm 1002 via the second joint portion 1007.

The second joint portion 1007 rotatably supports the second arm 1002 in the direction indicated by arrow c. The other end portion of the second arm 1002 is coupled to one end portion of the third arm 1003 via the third joint portion 1008. The third joint portion 1008 rotatably supports the third arm 1003 in the direction indicated by arrow d. The other end portion of the third arm 1003 has a chuck portion that will be described later, and the head holder 1009 is detachably attached to the chuck portion. The head 100 (or the head module 700) that discharges the coating material onto the coating target object U is attached to the head holder 1009.

The direction of rotation of each member in the articulated arm device 1100 is an example, and is not limited to the above. For example, a rotational operation with a rotation axis orthogonal to the rotation axis in each of rotating directions a, b, and c may be added.

The cleaning station 4000 is installed within the region that the articulated arm device 1100 of the coating robot 1000 can reach. When the standby time is equal to or longer than a certain time at the end of coating, or when the coating time has passed a prescribed time, the head 100 is moved to the cleaning station 4000 by the articulated arm device 1100. The cleaning station 4000 has a cleaning mechanism for cleaning the head 100, and performs a desired cleaning process on the head 100.

The robot controller 901 that controls operations and the like of the articulated arm device 1100 is electrically coupled to the coating robot 1000. The head controller 902 that controls operations of discharging a coating material from the head 100 and the like is electrically coupled to the head 100. The cleaning station controller 904 that controls operations and the like of the cleaning mechanism provided in the cleaning station 4000 is electrically coupled to the cleaning station 4000. Further, the main controller 900 that controls overall operations such as coating material discharge synchronization and synchronization control between the respective operations is electrically coupled to the robot controller 901, the head controller 902, and the cleaning station controller 904.

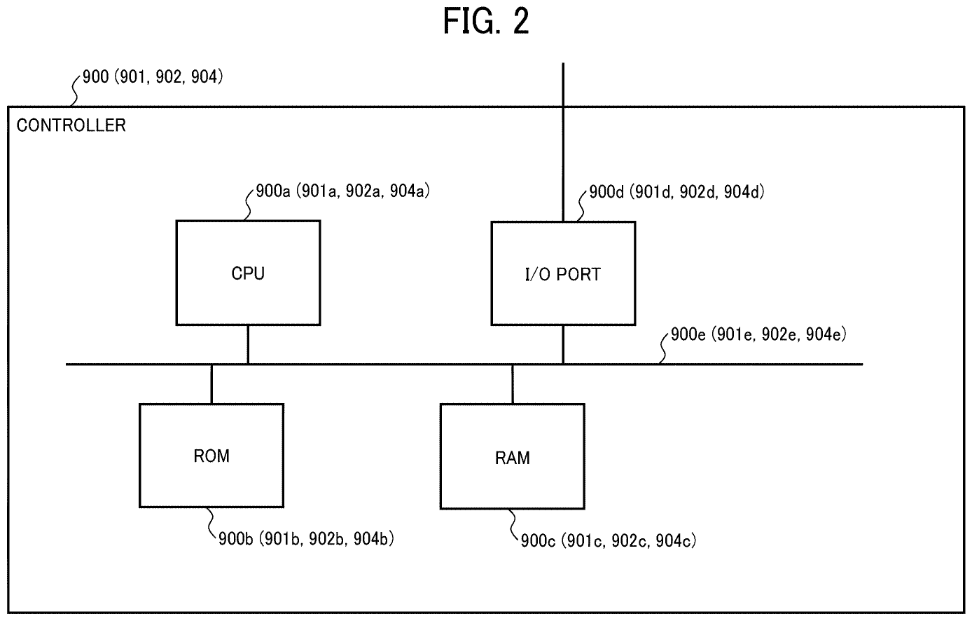

The main controller 900, the robot controller 901, the head controller 902, and the cleaning station controller 904 each have a configuration as illustrated in FIG. 2, for example. FIG. 2 is a hardware block diagram of each controller according to the embodiment.

The controllers 900, 901, 902, and 904 include central processing units (CPUs) 900a, 901a, 902a, and 904a, read only memories (ROMs) 900b, 901b, 902b, and 904b, random access memories (RAMs) 900c, 901c, 902c, and 904c, input/output (I/O) ports 900d, 901d, 902d, and 904d, and bus lines 900e, 901e, 902e, and 904e, respectively.

The CPUs 900a, 901a, 902a, and 904a are arithmetic units that execute programs stored in the ROMs 900b, 901b, 902b, and 904b to perform sequential processing, branch processing, iterative processing, and the like.

The ROMs 900b, 901b, 902b, and 904b are nonvolatile storage devices in which programs and the like to be executed by the CPUs 900a, 901a, 902a, and 904a are stored.

The RAMs 900c, 901c, 902c, and 904c are memories that function as work areas for operations of the CPUs 900a, 901a, 902a, and 904a.

The I/O ports 900d, 901d, 902d, and 904d are interfaces to which various types of signals and data such as output signals for various sensors installed in the coating system 10000 are input, and which output various types of signals such as drive signals to the head 100, the coating robot 1000, and the cleaning station 4000.

The bus lines 900e, 901e, 902e, and 904e are address buses, data buses, and the like for electrically coupling the respective components such as the CPUs 900a, 901a, 902a, and 904a.

For example, configuration information from an operating unit that operates the coating system 10000 may be input to the main controller 900 from the I/O port 900d, and output data to the other controllers 901, 902, and 904 may be output from the I/O port 900d.

The main controller 900, the robot controller 901, the head controller 902, and the cleaning station controller 904 are not necessarily provided independently of one another, but the functions of one or more of these controllers may be transferred to another controller.

Alternatively, the functions of the four controllers may be integrated into one controller.

The respective arms 1001, 1002, and 1003 of the coating robot 1000 operate when the drive motors in the respective joint portions 1006, 1007, and 1008 are controlled on the basis of an instruction from the robot controller 901. Thus, the head 100 can move in the X, Y, and Z directions with respect to the coating target object U.

### Configuration of the Head

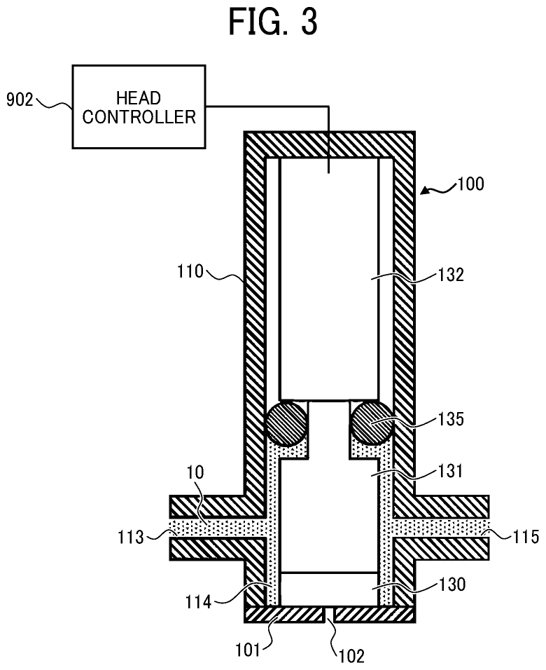

Next, the configuration of the head is described with reference to FIG. 3. FIG. 3 is a schematic cross-sectional view of an example of the head, and illustrates the configuration of a head minimum unit (one nozzle).

The head 100 includes a housing 110 designed to be hollow, and a nozzle plate 101 provided at one end portion of the housing 110. The nozzle plate 101 is a plate-like member in which a nozzle hole 102 for discharging a coating material 10 is formed. The nozzle hole 102 is a minute opening of about 0.04 to 0.15 mm in diameter.

The housing 110 has an injection port 113 and a discharge port 115 on side surfaces in the vicinity of the nozzle hole 102. The injection port 113 is for injecting the coating material 10, and the discharge port 115 is for discharging the coating material 10. The coating material 10 injected through the injection port 113 is sent to a liquid chamber 114 in the housing 110. Of the coating material 10 sent into the liquid chamber 114, the portion that has not been discharged through the nozzle hole 102 is discharged to the outside of the head 100 through the discharge port 115. The liquid chamber 114 is roughly formed with a space between the nozzle plate 101 and a sealing member 135 provided in the housing 110.

A needle 131 that is an example of a valve member is provided in the liquid chamber 114.

In the needle 131, a tip member 130 is joined to the tip portion on the side of the nozzle plate 101 so that the tip member 130 faces the nozzle hole 102. The tip member 130 is formed with an elastic body such as rubber, for example. As the tip member 130 is provided, adhesion to the nozzle hole 102 is enhanced, and the nozzle hole 102 can be closed more reliably. The configuration of the needle 131 is not limited to the above. The tip member 130 is not necessarily provided, and the nozzle hole 102 may be closed directly by the tip portion of the needle 131.

The sealing member 135 is formed with an O-ring, for example, and is fitted into the needle 131 so as to seal the gap between the inner surface of the housing 110 and the outer circumferential surface of the needle 131. Thus, the sealing member 135 prevents the coating material 10 in the liquid chamber 114 from flowing toward a piezoelectric element 132.

The piezoelectric element 132 is disposed in a space formed next to the liquid chamber 114 (above the liquid chamber 114 in FIG. 3), with the sealing member 135 serving as the boundary. The piezoelectric element 132 is electrically coupled to the head controller 902.

The piezoelectric element 132 moves the needle 131 between the position where the nozzle hole 102 is closed and the position where the nozzle hole 102 is opened, in accordance with a drive signal (a drive waveform) from the head controller 902.

At the position where the nozzle hole 102 is closed, the tip member 130 is in contact with the nozzle plate 101. At the position where the nozzle hole 102 is opened, the tip member 130 is separated from the nozzle plate 101. In a case where the tip member 130 is not provided, the needle 131 is in contact with the nozzle plate 101 at the position where the nozzle hole 102 is closed, and the needle 131 is separated from the nozzle plate 101 at the position where the nozzle hole 102 is opened.

The piezoelectric element 132 is a piezoelectric element that is formed with zirconia ceramics or the like. The shape and the like thereof are set as appropriate in accordance with the amount of droplets to be discharged or the like.

The head controller 902 is electrically coupled to the piezoelectric element 132, and applies a drive signal to the piezoelectric element 132 to control opening and closing of the needle 131.

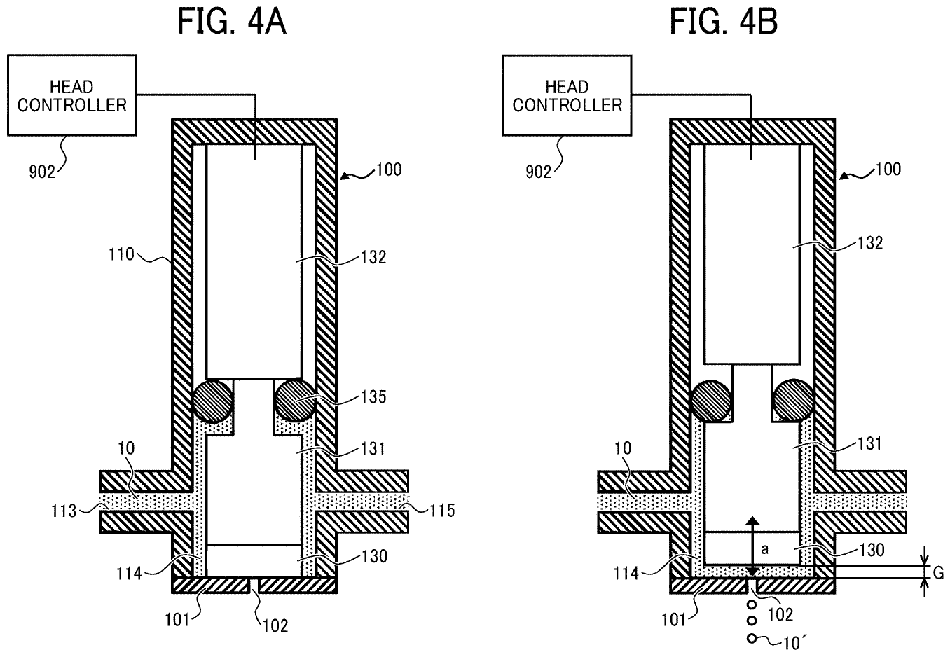

Next, operations of the head are described with reference to FIGS. 4A and 4B. FIGS. 4A and 4B are operation explanatory views of the head. FIG. 4A is a schematic cross-sectional view illustrating a state in which the nozzle hole is closed. FIG. 4B is a schematic cross-sectional view illustrating a state in which the nozzle hole is open.

In a case where a drive signal is applied to the piezoelectric element 132 by the head controller 902, when a closing voltage is applied to the piezoelectric element 132, the tip member 130 is in contact with the nozzle plate 101 and closes the nozzle hole 102 as illustrated in FIG. 4A. Because of this, the coating material 10 in the liquid chamber 114 is not discharged through the nozzle hole 102.

When an open voltage is applied to the piezoelectric element 132, the piezoelectric element 132 contracts, and moves the needle 131 upward in the drawing, as illustrated in FIG. 4B.

Because of this movement of the needle 131, the tip member 130 joined to the needle 131 moves to a position separated from the nozzle plate 101, and a gap G is formed between the tip portion of the tip member 130 and the nozzle hole 102. Since the coating material 10 in the liquid chamber 114 is pressurized and supplied at a predetermined pressure by the pressurized air to be described later, the coating material 10 in the liquid chamber 114 is discharged as droplets 10′ through the nozzle hole 102 while the gap G is formed.

When a drive voltage (a closing voltage or an open voltage) is applied from the head controller 902 to the piezoelectric element 132, the tip member 130 moves between a position in contact with the nozzle plate and a position separated from the nozzle plate 101 (or moves in the direction indicated by arrow a in FIG. 4B), and thus, the tip member 130 opens or closes the nozzle hole 102. The piezoelectric element 132 opens and closes the nozzle hole 102 at a high speed (about 2 kHz) via the needle 131, to enable discharge of the coating material 10 drop by drop.

### Configuration of the Head Module

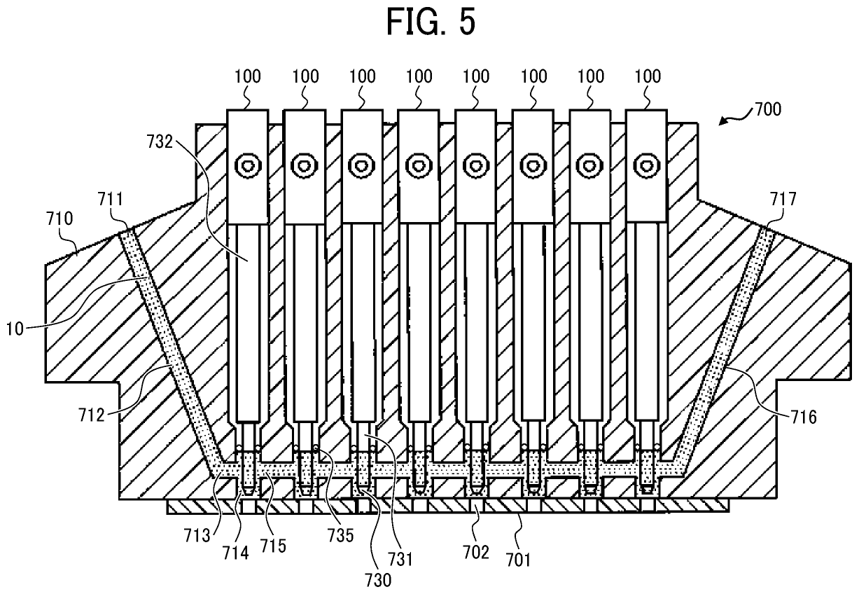

Next, the configuration of the head module is described with reference to FIG. 5. FIG. 5 is a schematic cross-sectional view of an example of the head module.

The head module 700 includes multiple (eight in this example) heads 100 in a housing 710.

The housing 710 has a supply port 711 for supplying the coating material 10 into the housing 710, a supply path 712 linking the supply port 711 to injection ports 713, and discharge ports 715 formed on the opposite side of liquid chambers 714 from the injection ports 713. The housing 710 also has a collection port 717 for collecting the coating material 10 in the housing 710, and a collection path 716 linking the discharge ports 715 to the collection port 717. The basic configuration of the multiple heads 100 is similar to the configuration described above with reference to FIG. 3 and FIGS. 4A and 4B. In FIG. 5, reference numerals in the 700's are used to denote the corresponding elements.

In this example, the eight heads 100 are provided so that the respective nozzle holes 702 are arranged at substantially equal intervals in one direction (a lateral direction in FIG. 5). Each of the heads 100 is disposed to extend in a vertical direction so as to discharge the coating material 10 downward through the nozzle hole 702 in the lower portion of the drawing. The liquid chambers 714 of the respective heads 100 are provided to penetrate so that the coating material 10 flows from one side (the left side in FIG. 5) to the other side (the right side in FIG. 5) in the array direction of the eight heads 100.

As described above, the head 100 in FIG. 3 and FIGS. 4A and 4B, and the head module 700 in FIG. 5 are designed as a valve on-off head or a valve on-off head module that causes the needles 131 (731) to open and close the nozzle holes 102 (702), to discharge the coating material 10. A desired number of the heads 100 or the head module 700 in a desired arrangement is attached to the head holder 1009 of the coating robot 1000.

### Outline of the Coating Material Supply and Discharge Paths

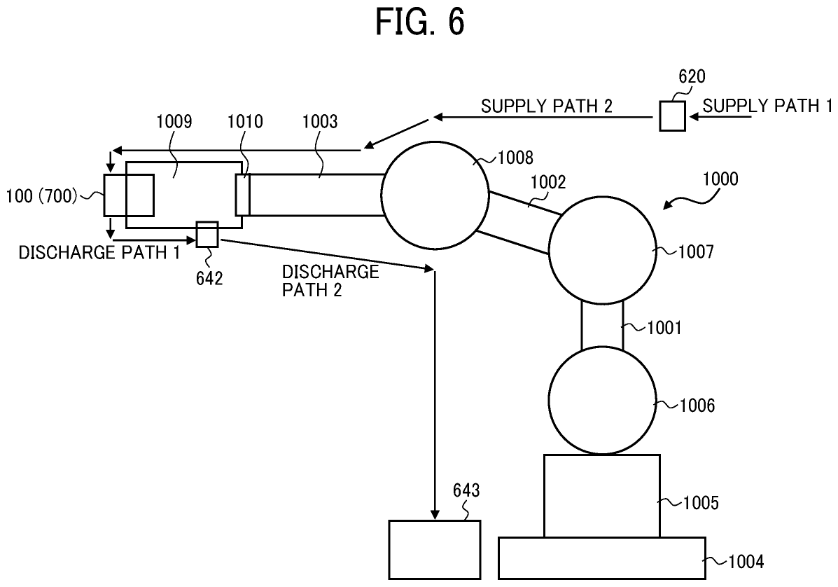

Next, the coating material supply and discharge paths are described with reference to FIG. 6. FIG. 6 is a schematic diagram illustrating the relationship between the coating robot and the supply and discharge paths. The components described above with reference to FIGS. 1 to 5, such as the configuration of the coating robot 1000, are denoted by the same reference numerals as above, and explanation thereof is not repeated herein.

One end portion of the third arm 1003 of the coating robot 1000 is coupled to the second arm 1002 via the third joint portion 1008. The other end portion of the third arm 1003 has a chuck portion 1010, and the head holder 1009 is detachably attached to this chuck portion.

The heads 100 (or the head module 700) are held by the coating robot 1000 via the head holder 1009.

As illustrated in the drawing, the coating material 10 is sent into a supply path 1 and a supply path 2 in this order, and is supplied to the injection ports 113 of the heads 100 (or the supply port 711 of the head module 700). A switching valve 620 that relays both supply paths is provided between the supply path 1 and the supply path 2. Although the switching valve 620 will be described later in detail, the switching valve 620 is used for switching coating materials when the color of the coating material to be supplied to the heads 100 (or the head module 700) is changed.

Further, the coating material 10 discharged from the discharge ports 115 of the heads 100 (or the collection port 717 of the head module 700) is sent to a discharge path 1 and a discharge path 2 in this order, and is discharged to a discharge device 643 as illustrated in the drawing.

A discharge valve 642 that relays both paths is provided between the discharge path 1 and the discharge path 2. The discharge valve 642 is a valve that enables opening and closing of the discharge paths. For example, when the color of the coating material to be supplied to the heads 100 (or the head module 700) is changed, the discharge valve 642 is opened, and the coating material or the like before switching is sent to the discharge device 643 through the discharge path 2.

### Configuration of the Coating Material Supply and Discharge Path

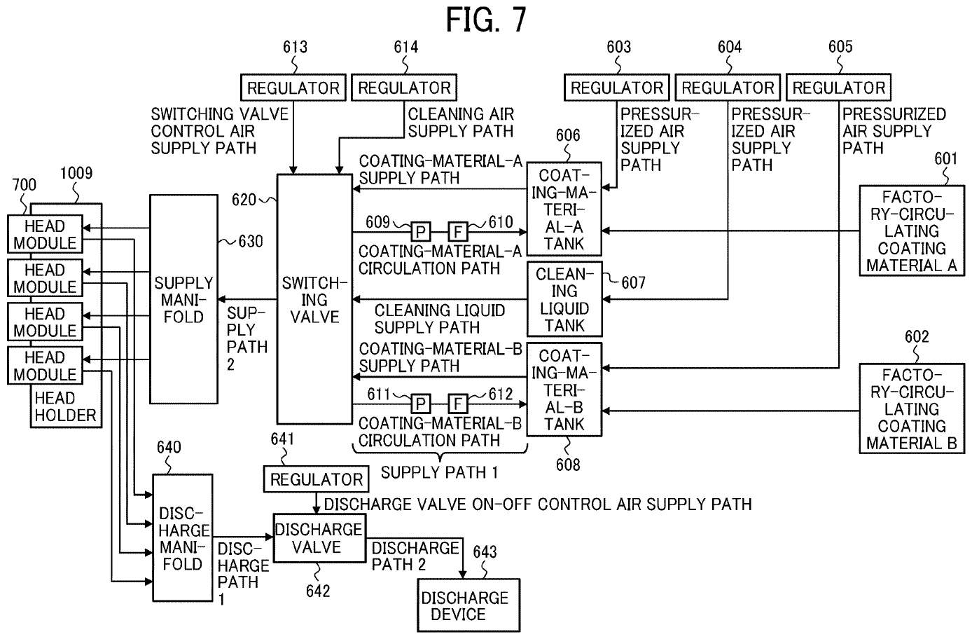

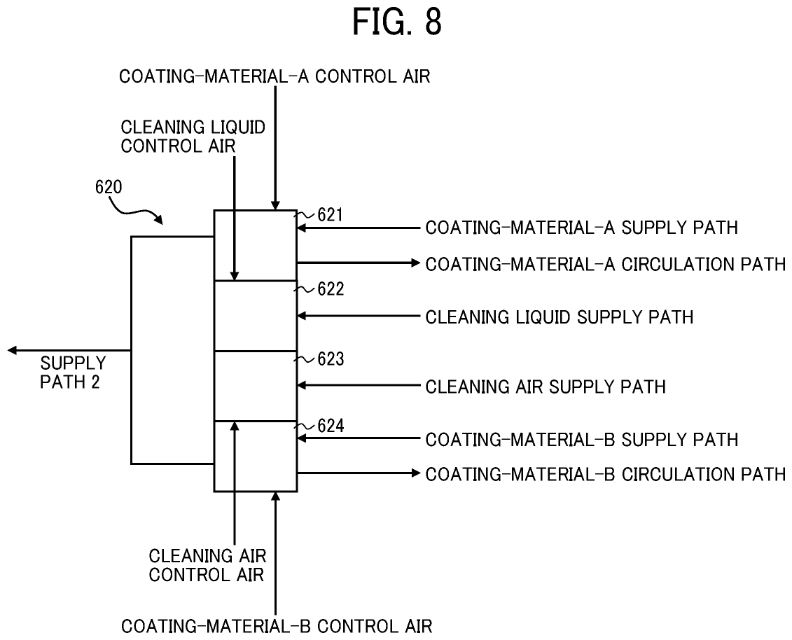

The coating material supply and discharge paths are now described in greater detail with reference to FIGS. 7 and 8. FIG. 7 is an explanatory diagram illustrating an example of the supply and discharge paths of the entire coating system. FIG. 8 is an explanatory diagram illustrating the configuration of the switching valve.

### Configuration of the Supply Path 1

In FIG. 7, the coating-material-A tank 606 stores a coating material A, a cleaning liquid tank 607 stores a cleaning liquid, and a coating-material-B tank 608 stores a coating material B different in type (for example, color) from the coating material A.

Here, the coating-material-A tank 606 and the coating-material-B tank 608 are an example of a coating material container. The path linking the respective tanks 606, 607, and 608 to the switching valve 620 is defined as the “supply path 1”. The supply path 1 includes a coating-material-A supply path, a coating-material-A circulation path, a cleaning liquid supply path, a coating-material-B supply path, and a coating-material-B circulation path.

A factory-circulating coating material A (601) circulating in the coating factory is supplied to the coating-material-A tank 606, and a factory-circulating coating material B (602) circulating in the coating factory is supplied to the coating-material-B tank 608. Regulators 603, 604, and 605 are coupled to the coating-material-A tank 606, the cleaning liquid tank 607, and the coating-material-B tank 608 via respective pressurized air supply paths. With this arrangement, the inside of each of the tanks 606, 607, and 608 is pressurized by the pressurized air supplied from the respective regulators 603, 604, and 605, and a coating material or a cleaning liquid can be pushed out from each of the tanks 606, 607, and 608.

The regulators 603, 604, and 605 is an example of an air supply unit.

The coating-material-A tank 606 is coupled to the switching valve 620 via the coating-material-A supply path.

The coating-material-A tank 606 is also coupled to the switching valve 620 via the coating-material-A circulation path. The coating-material-A supply path supplies the switching valve 620 the coating material A pushed out of the coating-material-A tank 606 by the pressurized air from the regulator 603. The coating-material-A circulation path returns the coating material A to the coating-material-A tank 606 in a case where the coating material A is not sent out from the switching valve 620 to the downstream side (the supply path 2).

While the coating material A is not sent out from the switching valve 620 in this manner, the coating material A is circulated on the upstream side of the switching valve 620 so as not to cause the solid components in the coating material to settle out.

When the coating material A is circulated between the coating-material-A tank 606 and the switching valve 620, the pressure to be applied to the coating-material-A tank 606 is set to about 0.1 MPa, and the coating material A can be returned to the coating-material-A tank 606 by a force of a pump 609 installed in the coating-material-A circulation path.

Further, a filter 610 is installed in the coating-material-A circulation path, to prevent entry of foreign matter into the coating-material-A tank 606.

The cleaning liquid tank 607 is coupled to the switching valve 620 via the cleaning liquid supply path.

The cleaning liquid supply path supplies the switching valve 620 the cleaning liquid pushed out of the cleaning liquid tank 607 by the pressurized air from the regulator 604.

The coating-material-B tank 608 is coupled to the switching valve 620 via the coating-material-B supply path.

The coating-material-B tank 608 is coupled to the switching valve 620 via the coating-material-B circulation path. The coating-material-B supply path supplies the switching valve 620 the coating material B pushed out of the coating-material-B tank 608 by the pressurized air from the regulator 605. The coating-material-B circulation path returns the coating material B to the coating-material-B tank 608 when the coating material B is not sent out from the switching valve 620 to the downstream side (the supply path 2). While the coating material B is not sent out from the switching valve 620 in this manner, the coating material B is circulated on the upstream side of the switching valve 620 so as not to cause the solid components in the coating material to settle out.

When the coating material B is circulated between the coating-material-B tank 608 and the switching valve 620, the pressure to be applied to the coating-material-B tank 608 is set to about 0.1 MPa, and the coating material B can be returned to the coating-material-B tank 608 by a force of a pump 611 installed in the coating-material-B circulation path.

Further, a filter 612 is installed in the coating-material-B circulation path, to prevent entry of foreign matter into the coating-material-B tank 608.

A regulator 613 is further coupled to the switching valve 620 via a switching valve control air supply path, and a regulator 614 is coupled to the switching valve 620 via a cleaning air supply path. The regulators 613 and 614 are an example of the air supply unit.

### Configuration of the Supply Path 2

The switching valve 620 is coupled to a supply manifold 630. Here, the path linking the switching valve 620 to the supply manifold 630 is defined as the “supply path 2”.

The supply manifold 630 branches the coating material A, the coating material B, or a cleaning agent sent out from the switching valve 620 to the supply path 2, and supplies the coating material A, the coating material B, or the cleaning agent to the supply port 711 of each head module 700. The supply path 2 does not necessarily include the supply manifold 630 in some cases. For example, in a case where there is one head module 700 held by the head holder 1009, and there is no need to branch the coating material A, the coating material B, or the cleaning agent sent out from the switching valve 620 to the supply path 2, the supply manifold 630 may not be provided. In that case, the supply path 2 is the path linking the switching valve 620 and the head module 700.

### Configuration of the Discharge Path 1

The collection port 717 of each head module 700 is coupled to a discharge manifold 640.

The discharge manifold 640 collects the coating material A, the coating material B, or the cleaning agent that has not been discharged through the nozzle holes 702 in the respective head modules 700. The discharge manifold 640 is coupled to the discharge valve 642.

Here, the path linking the discharge manifold 640 to the discharge valve 642 is defined as the “discharge path 1”.

The discharge path 1 does not include the discharge manifold 640 in some cases. For example, in a case where there is one head module 700 held by the head holder 1009, and there is no need to collect the coating material A, the coating material B, or the cleaning agent sent out from the head module 700 to the discharge path 1, the discharge manifold 640 may not be provided. In that case, the discharge path 1 is the path linking the head module 700 to the discharge valve 642.

### Configuration of the Discharge Path 2

The discharge valve 642 is coupled to the discharge device 643. Here, the path linking the discharge valve 642 to the discharge device 643 is defined as the “discharge path 2”. The discharge device 643 collects the coating material A, the coating material B, or the cleaning agent sent out from the discharge valve 642 to the discharge path 2, and processes the collected coating material A, coating material B, or cleaning agent as a waste liquid. A regulator 641 is further coupled to the discharge valve 642 via a discharge valve on-off control air supply path. The regulator 641 is an example of the air supply unit.

### Configuration of the Switching Valve

Next, the configuration of the switching valve 620 is described in slightly greater detail. As illustrated in FIG. 8, the switching valve 620 has four ports 621, 622, 623, and 624, for example.

Of the paths illustrated in FIG. 7, the coating-material-A supply path, the coating-material-A circulation path, and the switching valve control air supply path are assigned to the first port 621. The air supplied from the switching valve control air supply path is supplied to the first port 621 as a coating-material-A control air for sending the coating material A to the supply path 2.

Of the paths illustrated in FIG. 7, the cleaning liquid supply path and the switching valve control air supply path are assigned to the second port 622. The air supplied from the switching valve control air supply path is supplied to the second port 622 as a cleaning liquid control air for sending a cleaning liquid to the supply path 2.

Of the paths illustrated in FIG. 7, the cleaning air supply path and the switching valve control air supply path are assigned to the third port 623. The air supplied from the switching valve control air supply path is supplied to the third port 623 as cleaning air control air for sending a cleaning air to the supply path 2.

Of the paths illustrated in FIG. 7, the coating-material-B supply path, the coating-material-B circulation path, and the switching valve control air supply path are assigned to the fourth port 624. The air supplied from the switching valve control air supply path is supplied to the fourth port 624 as a coating-material-B control air for sending the coating material B to the supply path 2.

In the above configuration, a switching valve control air from the regulator 613 is supplied to one of the ports 621 to 624, in response to an instruction from the main controller 900 or the like. The port to which the switching valve control air is supplied is turned on to send the fluid (the coating material A, the coating material B, the cleaning liquid or cleaning air) allocated to the port to the supply path 2. Thus, the fluid sent out from the switching valve 620 to the supply path 2 is switched.

### Operation According to the Embodiment

In the description below, an example operation according to the embodiment is explained.

### Coating Material Filling Operation

In a case where coating is performed with the coating material A, it is necessary to fill the head module 700 with the coating material A. To fill the head module 700 with the coating material A, the coating-material-A control air supplied to the switching valve 620 is put into an on-state, and the coating material A is sent to the supply path 2. The pressure to be applied to the coating-material-A tank 606 when the head module 700 is filled with the coating material A is set to about 0.4 MPa. The discharge valve 642 installed in the discharge path is put into an open state at this point of time.

The coating material A sent from the switching valve 620 to the supply path 2 is branched by the supply manifold 630, and is supplied to the head module 700. When the coating material A is further supplied, the coating material A reaches the discharge valve 642 from the head module 700 through the discharge manifold 640 and the discharge path 1.

The discharge valve 642 is a valve that opens and closes between the discharge path 1 and the discharge path 2.

The discharge path 1 and the discharge path 2 do not have a path for returning to the supply path 2 (a path for returning the coating material A to the supply path 2). At the point of time when the coating material A fills even the discharge path 1, the discharge valve 642 is closed.

As a result, the head module 700 is filled with the coating material A in a pressurized state.

As the discharge valve 642 is closed, the coating material A is no longer sent to the discharge path 2 and the discharge device 643, so that the coating material A is not wasted.

The opening and closing of the discharge valve 642 is performed by turning on and off a discharge valve on-off control air supplied from the regulator 641. A needle 731 is driven in accordance with an instruction from the head controller 902, so that the coating material A filling the head module 700 is discharged through the nozzle holes 702. As any circulation path for circulating a fluid is not formed on the downstream side of the switching valve 620 in the fluid supply direction as described above, the coating material filling time can be shortened.

### Coating Material Switching Operation

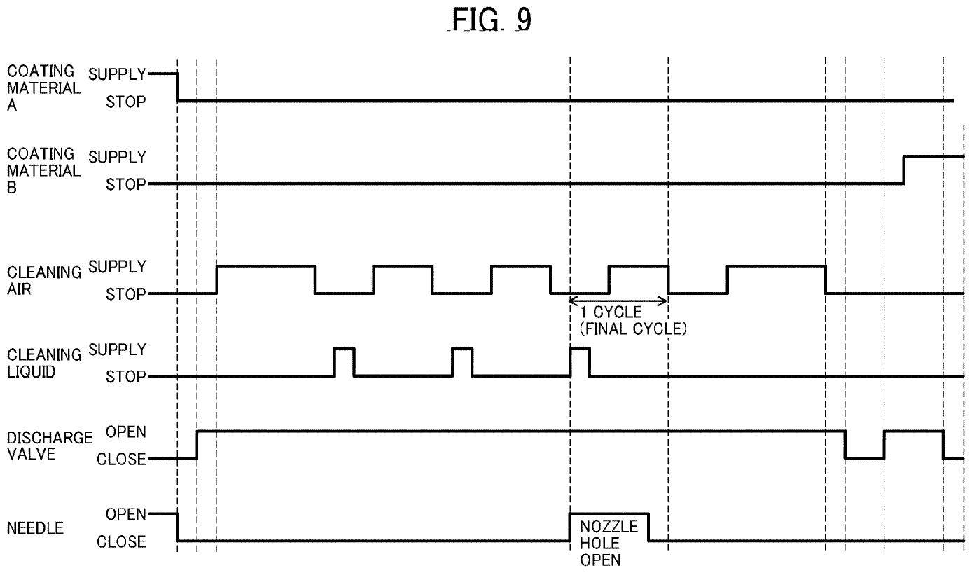

To switch the coating material from the coating material A being discharged to the coating material B, it is necessary to clean the supply paths (hereinafter also referred to as internal cleaning). In the description below, an internal cleaning operation is explained with reference to FIG. 9 in addition to FIGS. 7 and 8. FIG. 9 is a timing chart illustrating an example of the internal cleaning operation. FIG. 9 focuses on the on/off sequence of respective signals, and the individual pulse widths (times during which the signals are on, and the times during which the signals are off) may be changed as appropriate.

When the coating with the coating material A is finished, and the coating material needs to be switched (a color change, for example), the coating-material-A control air of the switching valve 620 is turned off, and the supply of the coating material A is stopped.

The discharge valve 642 is then opened, the cleaning air control air of the switching valve 620 is turned on. Thus, cleaning air is supplied to the supply path 2. The discharge valve 642 is opened prior to the start of supply of the cleaning air, to ensure a space for an air escape.

Thus, a problem such as peeling of the nozzle plate 701 due to the cleaning air having no place to escape can be prevented beforehand. At this point of time, the needle 731 of the head module 700 is closed (the nozzle holes 702 are closed), so that the coating material A remaining in the supply path 2, the head module 700, and the discharge path 1 is pushed out by the cleaning air, and is made to flow to the discharge device 643 through the discharge path 2. The cleaning air supply time is preferably set to a long time, to push out the coating material A to the discharge path 2. Hereinafter, the coating material remaining in the supply path 2, the head module 700, and the discharge path 1 will be also referred to as the residual coating material.

When most of the residual coating material A is pushed out to the discharge device 643, the cleaning air control air is turned off, and the supply of the cleaning air is stopped.

After the residual coating material A is pushed out by the cleaning air, a certain amount of the coating material A remains in the paths. Therefore, a cleaning liquid is then supplied to the supply path 2. The cleaning liquid is pressurized in the cleaning liquid tank 607 and is supplied to the switching valve 620. The cleaning liquid control air is put into an on-state, so that the cleaning liquid can be supplied toward the supply path 2. By the action of the cleaning liquid, it is possible to remove the residual coating material A that cannot be removed with the cleaning air.

In the present embodiment, the time during which the cleaning liquid control air is on is set to less than one second, and the amount of supply of the cleaning liquid to the supply path is set to an amount with which the cleaning liquid does not completely fill the supply path.

After the cleaning liquid is supplied, the cleaning air is supplied again, and the inside of the path is cleaned while a small amount of the cleaning liquid is pushed out to the discharge path by the force of the cleaning air. At this point of time, the needle 731 also remains closed, and the discharge valve 642 remains open (the discharge valve is kept open).

When the cleaning in the path on the downstream side of the switching valve 620 is completed by the actions of the cleaning air and the cleaning liquid, the discharge valve 642 is closed once. When the coating material B is supplied from the switching valve 620, the discharge valve 642 is then opened again. The coating material B then fills even the discharge path 1, and thus, is put into a dischargeable state, as in the filling operation with the coating material A. When the discharge path 1 is filled with the coating material B, the discharge valve 642 is closed.

As described above, the switching from the coating material A to the coating material B can be performed without replacing the head module 700 or the head holder 1009. In addition to the nozzle holes 702 for discharging the coating material, the head module 700 further includes the collection path 716 for discharging the coating material that has not been discharged through the nozzle holes 702. In a case where the head module 700 does not include the collection path 716, the coating material to be discharged also needs to be discharged through the nozzle holes 702. In that case, to prevent the coating material to be discharged from scattering in the coating area, it is necessary to perform the discharging operation after coupling the head module to a dedicated cleaning station.

In the embodiment, on the other hand, the head module 700 includes the collection path 716.

Accordingly, the discharge valve 642 can be opened to start the discharging operation immediately after completion of the coating. Thus, the coating material switching time can be significantly shortened.

As described above, the present embodiment is the coating system 10000 that includes: the heads 100 (or the head module 700) that have the nozzle holes 102 (or 702) through which a coating material is discharged, and are coupled to the supply paths 1 and 2 to which the coating material is supplied and the discharge paths 1 and 2 for discharging the coating material that has not been discharged through the nozzle holes 102; the coating robot 1000 that has the articulated arm device 1100 that moves the heads 100 (or the head module 700); the switching valve 620 that is coupled to multiple coating material tanks 606 and 608 containing different types of coating materials, and switches the coating material to be supplied to the supply path 2; the discharge valve 642 that opens and closes the discharge paths 1 and 2; and the main controller 900 that controls opening and closing of the discharge valve 642. In a case where the coating material to be supplied to the supply path 2 is switched, the main controller 900 opens the discharge valve 642 with the heads 100 (or the head module 700) remaining attached to the articulated arm device 1100, after completion of a coating operation with the coating material (the coating material A, for example) prior to switching.

Accordingly, the discharge valve 642 is opened to start a discharging operation (the internal cleaning) immediately after completion of coating. Thus, the coating material switching time can be shortened.

Further, the coating material adheres to the nozzle surface (the surface of the nozzle plate 701) after discharge of the coating material. Therefore, it is preferable to perform nozzle surface cleaning in addition to the internal cleaning. Since the nozzle surface is a surface exposed to the outside through the head module 700, cleaning of the nozzle surface is performed in the cleaning station 4000. Therefore, the head module 700 is moved to the cleaning station 4000 by the coating robot 1000. In this case, the articulated arm device 1100 of the coating robot 1000 is operated while the discharge valve 642 remains open (is kept open), so that the head module 700 is positioned in the cleaning station 4000.

As the head module 700 has the collection path 716, there is no need to wait for the start of the internal cleaning until the head module 700 reaches the cleaning station 4000 in this case, and the internal cleaning can be performed even during the moving by the coating robot 1000.

As described above, the present embodiment further includes the cleaning station 4000 that cleans the nozzle surfaces of the heads 100 (or the head module 700), and the main controller 900 controls the articulated arm device 1100 so that the heads 100 (or the head module 700) are positioned in the cleaning station 4000 while the discharge valve 642 remains (is kept) in an open state.

As a result, the entire coating material switching time, including the nozzle surface cleaning time, can be shortened.

In the internal cleaning, cleaning air is first supplied before a cleaning liquid is supplied to the supply path 2. As the cleaning air is supplied first, the residual coating material A can be pushed out by the cleaning air, and most of the residual coating material A can be discharged.

Thus, the amount of the cleaning liquid to be used for washing away the residual coating material A can be reduced.

As described above, in the present embodiment, each head 100 (or the head module 700) includes the needle 131 (or 731) that opens and closes the nozzle hole 102 (or 702). The switching valve 620 is coupled to the multiple coating material tanks 606 and 608, the cleaning liquid tank 607 containing a cleaning liquid, and the regulator 614 that supplies the cleaning air. When the coating material to be supplied to the supply path 2 is switched, the main controller 900 performs control so that the needle 131 (or 731) closes the nozzle hole 102 (or 702) while the discharge valve 642 remains (is kept) in an open state after completion of a coating operation with a coating material (the coating material A, for example) prior to the switching. The cleaning air is supplied from the switching valve 620 first to the supply path 2.

After the cleaning air supply is completed, a cleaning liquid is supplied from the switching valve 620 to the supply path 2, with the needle 131 (or 731) still closing the nozzle hole 102 (or 702). That is, the cleaning liquid is supplied from the switching valve 620 to the supply path 2 while keeping the nozzle hole 102 (or 702) closed by the needle 131 (or 731). After the cleaning liquid supply is completed, the cleaning air is supplied again.

Thus, the amount of the cleaning liquid to be used can be reduced.

In the internal cleaning, the cleaning air and the cleaning liquid may be repeatedly supplied.

For example, a cleaning liquid supplying operation and a cleaning air re-supplying operation are set as one cycle, and this cycle is repeated.

As a result of this, the opportunities to push out the residual coating material with the cleaning air (the number of times the cleaning liquid comes into contact with the residual coating material) increases, and cleaning efficiency can be increased with a smaller amount of the cleaning liquid used.

Although the needle 731 is closed during the internal cleaning, an extremely small amount of coating material remains between the tip of the needle 731 and the nozzle plate 701.

Therefore, in the final cycle of the repeated cycles with the cleaning air and the cleaning liquid during the internal cleaning, an operation of opening and closing the needle 731 at least once (preferably, multiple successive times) is performed to discharge the cleaning liquid through the nozzle hole 702. This operation makes it possible to wash away the coating material remaining between the tip of the needle 731 and the nozzle plate 701.

In this case, the needle 731 is driven so that the discharge of the cleaning liquid through the nozzle hole 702 is performed, with the head module 700 being coupled to the cleaning station 4000. Thus, the cleaning liquid does not scatter onto the coating target object U or in the coating area, and the coating material and the cleaning liquid discharged through the nozzle holes 702 are collected by the cleaning station 4000.

As described above, the head module 700 moves to the cleaning station 4000 while performing the internal cleaning. In the stage of discharging the cleaning liquid through the nozzle holes 702, the head module 700 has already reached the cleaning station 4000, and therefore, productivity is not degraded.

At the time of the final cycle of the repeated cycles, the inside of the supply path has already been cleaned, and an extremely small amount of the coating material remains between the tip of the needle 731 and the nozzle plate 701. As the needle 731 is driven in this state, the amount of the coating material to be discharged through the nozzle holes 702 at the time of internal cleaning can be minimized, and contamination due to the coating material in the cleaning station 4000 can also be minimized.

As described above, in the present embodiment, in the final cycle of the repeated cycles described above, each head 100 (or the head module 700) is located in the cleaning station 4000, and the needle 131 (or 731) is opened and closed at least once.

This can minimize contamination in the cleaning station.

Further, in the final cycle of the repeated cycles with the cleaning air and the cleaning liquid, the discharge valve 642 is also in an open state while the needle 731 performs the opening/closing operation. The time during which the cleaning liquid control air is on is set to less than one second, and the amount of supply of the cleaning liquid to the supply path is set to an amount that does not cause the cleaning liquid to completely fill the supply path.

The cleaning liquid is pushed through the entire supply path by the feeding pressure of the cleaning air. The time during which the cleaning liquid control air is on is less than one second, and most of the time during which the needle 731 performs an opening and closing operation is a time during which the cleaning air is supplied from the switching valve 620.

At this point of time, it is possible to discharge the cleaning liquid through the nozzle holes 702 even when the discharge valve 642 is closed. However, since the nozzle holes 702 are minute openings of about 0.04 to 0.15 mm, the pressure loss is large, and the cleaning air hardly flows. Therefore, the flow of the cleaning liquid remaining in the supply path deteriorates. The discharge valve 642 is opened to achieve an atmospheric open state.

Accordingly, the cleaning liquid easily flows in the supply path, the amount of supply of the cleaning liquid into the head module 700 increases, and the cleaning properties of the nozzle holes 702 are enhanced.

As described above, in the present embodiment, the discharge valve 642 is kept open while the needle 131 (or 731) is opened and closed in the final cycle.

In this manner, the pressure in the paths is released, so that the flow of the cleaning liquid in the paths can be enhanced.

After the repeated cycles with the cleaning air and the cleaning liquid are completed, the needle 731 is closed, and the cleaning air is supplied from the switching valve 620. As the cleaning air is supplied lastly, the cleaning liquid remaining in the supply path is pushed out to the discharge device 643 without fail, and it is possible to prevent the coating material from being diluted by the remaining cleaning liquid when the switched coating material (the coating material B, for example) fills the supply path after completion of the internal cleaning.

The time of the last supply of the cleaning air is preferably set to be long like the first air supply time, to discharge the remaining cleaning liquid without fail. The discharge valve 642 is closed after the supply of the cleaning air is stopped. Thus, a problem such as peeling of the nozzle plate 701 due to the cleaning air having no place to escape can be prevented beforehand.

As described above, in the present embodiment, after the final cycle is performed, the needle 131 (or 731) is closed, and the cleaning air is supplied from the switching valve 620 to the supply path 2.

As a result, there will be no cleaning liquid remaining in the path at the next time of filling of the coating material, and the coating material can be prevented from being diluted.

Further, it is preferable to clean the nozzle surface after the internal cleaning. Examples of nozzle surface cleaning means include a wiper-type cleaning device. While the nozzle surface is cleaned by a cleaning device, the needle 731 may be closed to supply the cleaning air into the path. In this case, the cleaning of the nozzle surface and the supply of the cleaning air for pushing out the cleaning liquid in the path can be performed in parallel, and thus, the total time to be taken for the cleaning of the nozzle surface and the internal cleaning can be shortened.

As described above, according to the present embodiment, the nozzle surface of each head 100 (or head module 700) is cleaned at the cleaning station 4000 while the cleaning air is supplied.

Thus, the total time to be taken for the cleaning of the nozzle surface and the internal cleaning can be shortened.

### Another Example Configuration of a Head

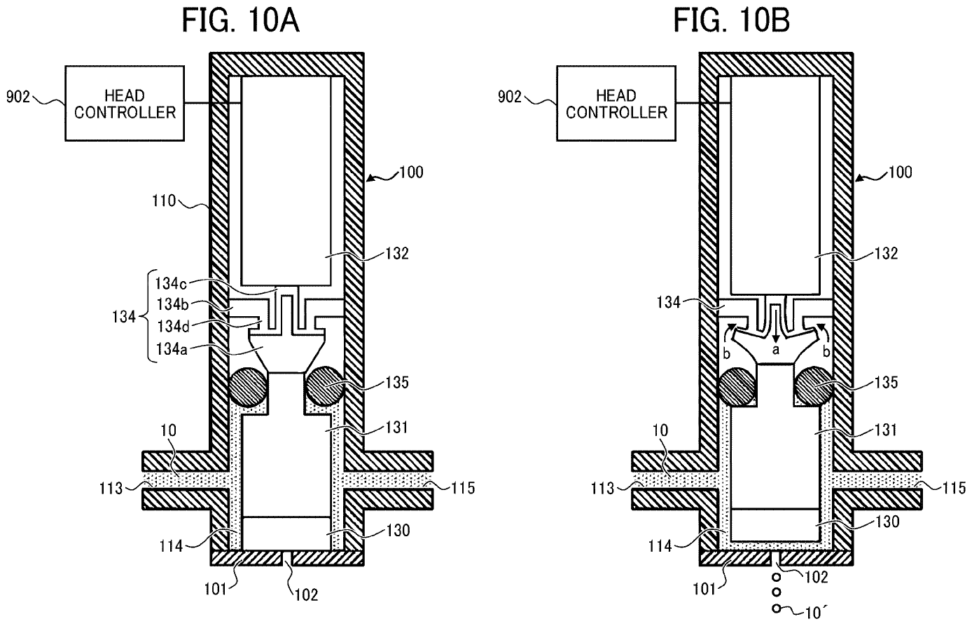

Another configuration of a head is now described with reference to FIGS. 10A and 10B.

FIGS. 10A and 10B are schematic cross-sectional view of another example of a head, and illustrate the configuration of a head minimum unit (one nozzle). FIG. 10A is a cross-sectional view illustrating a state in which the nozzle hole is closed, and FIG. 10B is a cross-sectional view illustrating a state in which the nozzle hole is open.

This example configuration differs from the configuration of the head illustrated in FIG. 3 and FIGS. 4A and 4B in that a reverse spring mechanism 134 is provided between the needle 131 and the piezoelectric element 132. Therefore, the configuration and operation of the reverse spring mechanism 134 are mainly described herein. The components having the same configurations and functions as the components of the head in FIG. 3 and FIGS. 4A and 4B are denoted by the same reference numerals as the reference numerals used in FIG. 3 and FIGS. 4A and 4B, and explanation thereof is not made herein. In this example configuration, a piezoelectric element having expansion/contraction characteristics to extend toward the nozzle plate 101 when an open voltage VL is applied is used as the piezoelectric element 132.

The reverse spring mechanism 134 is an elastic member formed by molding an appropriately deformable rubber, soft resin, thin metal plate, or the like. The reverse spring mechanism 134 includes a deformable portion 134a, a secured portion 134b, a guide portion 134c, and a bent side 134d.

The deformable portion 134a has a substantially trapezoidal cross-section so as to come into contact with the face on the base end side of the needle 131 (the upper end face of the needle 131 in FIG. 10A). The secured portion 134b is secured to the deformable portion 134a and the inner wall face of the housing 110. The guide portion 134c couples the secured portion 134b and the piezoelectric element 132 to each other. The bent side 134d couples the long side (corresponding to the lower base of the trapezoid) of the trapezoidal deformable portion 134a and the secured portion 134b to each other.

In the reverse spring mechanism 134 having the configuration as above, when the predetermined open voltage VL is applied to the piezoelectric element 132, and the piezoelectric element 132 becomes longer, the guide portion 134c is pushed toward the nozzle hole 102 (in the direction indicated by arrow a in FIG. 10B) by the extension of the piezoelectric element 132. With this pressing force, the deformable portion 134a is drawn in the direction away from the nozzle hole 102 (the direction indicated by arrows b in FIG. 10B).

That is, in the case of the head including the reverse spring mechanism 134, the direction of opening and closing of the needle 131 (or the tip member 130) with respect to the polarity of the applied drive voltage is opposite to the corresponding direction in a head not including the reverse spring mechanism 134. The reverse spring mechanism 134 converts the stretching force of the piezoelectric element 132 into a force for drawing the needle 131, and transmits the force to the needle 131.

In the head 100 according to this example configuration, when a voltage is applied to the piezoelectric element 132, the piezoelectric element 132 extends. Accordingly, the tip member 130 opens the nozzle hole 102, and the droplets 10′ are discharged through the nozzle hole 102.

In a case where the head 100 of this example configuration is used in the coating system 10000 described above, the same functions and effects as the functions and effects of the head in FIG. 3 and FIGS. 4A and 4B can be achieved. Furthermore, the head 100 including the reverse spring mechanism 134 can obtain a large displacement with a small displacement of the piezoelectric element 132, compared with a head not including a reverse spring mechanism.

The above description concerns an example, and the present embodiment exhibits unique effects for each of the following aspects.

### Aspect 1

According to Aspect 1, a coating system (the coating system 10000, for example) includes: a head (the head 100 or the head module 700, for example) that has a nozzle hole through which a coating material is discharged, and is coupled to a supply path (the supply paths 1 and 2, for example) to which the coating material is supplied and a discharge path (the discharge paths 1 and 2, for example) for discharging the coating material that has not been discharged through the nozzle hole; a robot (the coating robot 1000, for example) that includes a movement mechanism (the articulated arm device 1100, for example) that moves the head; a switching valve (the switching valve 620, for example) that is coupled to multiple coating material containers (the coating-material-A tank 606 and the coating-material-B tank 608, for example) containing different types of coating materials, and switches the coating material to be supplied to the supply path; a discharge valve (the discharge valve 642, for example) that opens and closes the discharge path; and a controller (the main controller 900, for example) that controls opening and closing of the discharge valve. When the coating material to be supplied to the supply path is switched, the controller opens the discharge valve, while with the head remaining attached to the movement mechanism, after completion of a coating operation with a coating material (the coating material A, for example) prior to switching.

### Aspect 2

According to Aspect 2, the coating system of Aspect 1 further includes a cleaning station (the cleaning station 4000, for example) that cleans a nozzle surface of the head, and the controller controls the movement mechanism to position the head in the cleaning station, with the discharge valve open.

### Aspect 3

According to Aspect 3, in Aspect 1 or Aspect 2, the head includes a valve member (the needle 131 or 731, for example) that opens and closes the nozzle hole, and the switching valve is coupled to the multiple coating material containers, a cleaning liquid container (the cleaning liquid tank 607, for example) that stores a cleaning liquid, and an air supply unit (the regulator 614, for example) that supplies cleaning air. When the coating material to be supplied to the supply path is switched, after completion of the coating operation with the coating material prior to switching, the controller performs control to make the valve member close the nozzle hole with the discharge valve open, and to supply the cleaning air from the switching valve first to the supply path.

### Aspect 4

According to Aspect 4, in Aspect 3, after supply of the cleaning air is completed, the cleaning liquid is supplied from the switching valve to the supply path while the valve member continues to close the nozzle hole, and, after supply of the cleaning liquid is completed, the cleaning air is re-supplied.

### Aspect 5

According to Aspect 5, in Aspect 4, an operation of supplying the cleaning liquid and an operation of re-supplying the cleaning air are set as a cycle, and the cycle is repeatedly performed.

### Aspect 6

According to Aspect 6, in Aspect 5, in a final cycle of repetition of the cycle, the head is positioned in the cleaning station, and the valve member is opened and closed at least once.

### Aspect 7

According to Aspect 7, in the Aspect 6, while the valve member is opened and closed, the discharge valve stays open.

### Aspect 8

According to Aspect 8, in the Aspect 6 or Aspect 7, after the final cycle is performed, the valve member is closed, and the cleaning air is supplied from the switching valve to the supply path (the supply path 2, for example).

### Aspect 9

According to Aspect 9, in Aspect 8, while the cleaning air is supplied, the nozzle surface of the head is cleaned at the cleaning station.

### Aspect 10

According to Aspect 10, a head cleaning method is implemented in a coating system including: a head that has a nozzle hole through which a coating material is discharged, and is coupled to a supply path to which the coating material is supplied and a discharge path for discharging the coating material that has not been discharged through the nozzle hole; a robot that includes a movement mechanism that moves the head; a switching valve that is coupled to multiple coating material containers containing different types of coating materials, and switches the coating material to be supplied to the supply path; a discharge valve that opens and closes the discharge path; and a controller that controls opening and closing of the discharge valve. The head cleaning method includes, in a step of switching the coating material to be supplied to the supply path: a step of opening the discharge valve, with the head remaining attached to the movement mechanism, after completion of a coating operation with the coating material prior to switching; and a step of starting internal cleaning of the head, after the step of opening the discharge valve.

The above-described embodiments are illustrative and do not limit the present invention.

Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2023-003553, filed on Jan. 13, 2023, in the Japan Patent Office, the entire disclosure of which is hereby incorporated by reference herein.

### REFERENCE SIGNS LIST

100 Head
101 Nozzle plate
102 Nozzle hole
131 Needle (an example of the valve member)
132 Piezoelectric element
601 Factory-circulating coating material A
602 Factory-circulating coating material B
603 Regulator (an example of the air supply unit)
604 Regulator (an example of the air supply unit)
605 Regulator (an example of the air supply unit)
606 Coating-material-A tank (an example of the coating material container)
607 Cleaning liquid tank (an example of the cleaning liquid container)
608 Coating-material-B tank (an example of the coating material container)
613 Regulator (an example of the air supply unit)
614 Regulator (an example of the air supply unit)
620 Switching valve
630 Supply manifold
640 Discharge manifold
641 Regulator (an example of the air supply unit)
642 Discharge valve
643 Discharge device
700 Head module
701 Nozzle plate
702 Nozzle hole
731 Needle (an example of the valve member)
732 Piezoelectric element
900 Main controller (an example of the controller)
901 Robot controller (an example of the controller)
902 Head controller (an example of the controller)
904 Cleaning station controller (an example of the controller)
1000 Coating robot (an example of the robot)
1001 First arm
1002 Second arm
1003 Third arm
1009 Head holder
1010 Chuck portion
1100 Articulated arm device (an example of the movement mechanism)
4000 Cleaning station
10000 Coating system

1. A coating system comprising:
a head having a nozzle hole through which a coating material is dischargeable;
a supply path coupled to the head to supply the coating material to the head;
a discharge path coupled to the head to discharge the coating material that has not been discharged through the nozzle hole;
a robot including a mover to move the head attached to the mover;
a switching valve coupled to multiple coating material containers containing different types of coating materials, the switching valve to switch a first type of coating material to a second type of coating material, different from the first type of coating material, to be supplied to the supply path;
a discharge valve to openably close the discharge path; and
control circuitry configured to:
control the head to openably close the nozzle hole to discharge the first type of coating material from the nozzle hole to perform a coating operation;
open the discharge valve to discharge the first type of coating material to the discharge path, with the head attached to the mover, after completion of the coating operation; and
control the switching valve to supply the second type of coating material to the supply path after completion of discharge of the first type of coating material to the discharge path.

2. The coating system of claim 1, further comprising:
a cleaning station to clean a nozzle surface having the nozzle hole of the head,
wherein the control circuitry is further configured to control the mover of the robot to position the head in the cleaning station while keeping the discharge valve opened.

3. The coating system of claim 1, wherein:
the head includes a valve member to openably close the nozzle hole,
the switching valve is further coupled to a cleaning liquid container to store a cleaning liquid and an air supply unit to supply cleaning air, and
the control circuitry is further configured to:
after the coating operation with the first type of coating material,
control the switching valve to switch the first type of coating material to the cleaning air to supply the cleaning air to the supply path while keeping the nozzle hole closed by the valve member and keeping the discharge valve opened.

4. The coating system of claim 3, wherein the control circuitry is further configured to:
after completion of supply of the cleaning air to the supply path,
control the switching valve to switch the cleaning air to the cleaning liquid to supply the cleaning liquid to the supply path while keeping the nozzle hole closed by the valve member and keeping the discharge valve opened; and
control the switching valve to switch the cleaning liquid to the cleaning air to supply the cleaning air to the supply path again after completion of supply of the cleaning liquid to the supply path.

5. The coating system of claim 4, wherein;
the control circuitry is further configured to repeatedly perform a cycle including:
the supply of the cleaning liquid to the supply path; and
resuming the supply of the cleaning air to the supply path.

6. The coating system of claim 5, further comprising:
a cleaning station to clean a nozzle surface having the nozzle hole of the head,
wherein the control circuitry is further configured to:
in a final cycle of repetition of the cycle, control the mover of the robot to position the head in the cleaning station; and control the head to move the valve member to open and close the nozzle hole at least once.

7. The coating system of claim 6, wherein the control circuitry is further configured to:
control the head to move the valve member to open and close the nozzle hole while keeping the discharge valve opened.

8. The coating system of claim 6, wherein the control circuitry is further configured to:
after the final cycle is performed, control the switching valve to supply the cleaning air to the supply path while keeping the valve member of the head closed.

9. The coating system of claim 8, wherein;
the control circuitry is further configured to control the cleaning station to clean the nozzle surface of the head while supplying the cleaning air to the head.

10. A head cleaning method comprising:
discharging a coating material from a nozzle hole of a head;
supplying the coating material to the head through a supply path;
discharging the coating material that has not been discharged through the nozzle hole through a discharge path;
controlling a mover of a robot to move the head attached to the mover;
switching a switching valve coupled to multiple coating material containers containing different types of coating materials, to switch a first type of coating material to a second type of coating material, different from the first type of coating material, to be supplied to the supply path;
opening and closing a discharge valve to open and close the discharge path;
controlling the head to openably close the nozzle hole to discharge the first type of coating material from the nozzle hole to perform a coating operation;
opening the discharge valve to discharge the first type of coating material to the discharge path, with the head attached to the mover, after completion of the coating operation; and
controlling the switching valve to supply the second type of coating material to the supply path after completion of discharge of the first type of coating material to the discharge path.
